(19) United States
(12) Patent Application Publication
(10) Pub. No.: US 2012/0196092 A1
(43) Pub. Date: Aug. 2, 2012

(54) DEVICE FOR ROLLING AN ECCENTRIC ROTATIONAL COMPONENT, ROLLING MACHINE, METHOD, AND ECCENTRIC ROTATIONAL COMPONENT

(76) Inventor: Karsten Röttger, Celle (DE)

(21) Appl. No.: 13/384,991

(22) PCT Filed: May 31, 2010
(86) PCT No.: PCT/DE2010/000601

§ 371 Date: Apr. 4, 2012

(30) Foreign Application Priority Data
Jul. 21, 2009 (DE) 10 2009 034 291.5
Feb. 19, 2010 (DE) 10 2010 008 694.0

(51) Int. Cl. B24B 39/04; B32B 1/00

(52) U.S. Cl. 428/174; 29/90.5

(57) ABSTRACT

A tool for rolling an eccentric rotational component having an eccentric portion, in particular an eccentric worm shaft, wherein the tool has a rotational device having rolling device, by means of which the surface edge zone of the eccentric rotational component is strengthened in order to increase the service life thereof. In an embodiment example, a cutting process is performed before the rolling process.

### BACKGROUND

1. Field of the Invention

The disclosure relates to a tool for rolling an eccentric rotational component with an eccentric part, more specifically an eccentric worm shaft, a method for manufacturing a rolled rotational component and a rotational component.

2. Discussion of the Background Art

The field of application of eccentric worm shafts which are also called mono pump shafts could not be broader. The use of eccentric worm shafts ranges from the food industry to oil production to vehicle construction, shipbuilding and a plurality of other application areas in which they are used for conveying any number of media.

In almost all these applications, the quality and longevity of the eccentric worm shaft is a major focus. The properties of the edge zone of the component, such as surface roughness, hardness of the edge zone and the state of the internal stress are decisive with regard to the durability and qualitative properties of the eccentric worm shaft.

Eccentric worm shafts are machined by whirling in lengths of up to 6 meters. In many cases, the surfaces are hardened or hard plated followed by a complex polishing of the surface.

These laborious and costly measures serve to increase the wear resistance and thus to increase the longevity of the component. However, manufacturing methods such as hard chrome plating result in higher costs and other negative accessory characteristics. Hard chrome plating produces a wear resistant surface but the corrosion between the chrome and the base material often leads to early failures.

The object is to improve the prior art.

### SUMMARY

According to a first aspect of the disclosure, the object is solved by a tool for rolling and eccentric rotational component with an eccentric part, more specifically for rolling an eccentric worm shaft, the tool having a rotational device with a rolling device so that the eccentric part can be rolled through the rolling device.

Smoothing and shaping the surface can be achieved with this tool. Furthermore, a hardening or improvement of the internal compressive stress with regard to the corrosion and wear can be achieved during rolling. An eccentric worm shaft can thus be provided which ensures an extension of the longevity of the component.

The following terms must be explained:

The “tool” can be operated with a rolling machine. Such a rolling machine is more specifically a whirling machine or a lathe. The eccentric shaft worm to be machined can be inserted into this tool, so that a rolling of the eccentric parts can be carried out.

The “eccentric part” of the eccentric rotational component has more specifically a pitch, so that in the case of an eccentric worm shaft for instance, a principle of conveyance as in an Archimedean screw can be implemented. The eccentric rotational component can additionally have a non-eccentric part, this non-eccentric part serving more specifically for admission into a motor.

The “rotation device” more specifically carries out a rotation around a rotational axis of the eccentric rotational component. This rotational axis can be oriented axially or coaxially relative to the conveying direction of an eccentric worm shaft.

The “rolling device” can roll the surface of the eccentric rotational component. The surface of this eccentric rotational component can be formed by this rolling, more specifically by burnishing or roller compression. By connecting the rolling device with the rotational device, the rolling device can carry out an extensive rolling.

In one embodiment a fixed stator is provided, which is configured so as to be static relative to the rotational device. A mounting onto the rolling machine can occur directly via the stator or via a tool holder.

In order to be able to roll a worm pitch of an eccentric rotational component, the rolling device can have a hydrostatic burnishing element, which has a ball insert with a hard material component. Such hydrostatic burnishing elements can for instance be configured according to the documents DE 103 40 267 A1 or DE 101 33 314 A1. A ceramic component can be used for machining the eccentric rotational component, so that the hard material component is made entirely or in parts of ceramic. The ball in the ball insert can thereby be made of ceramic or coated with ceramics. High press forces can thereby be punctually achieved.

In another embodiment, the rolling device or the burnishing element has a lift of approximately 1 mm to 20 mm, the lift amounting more specifically to approximately 8.5 mm. Inhomogeneities of the surface of the eccentric worm shaft can thus be advantageously compensated for without wear.

In order to reduce the rotational speed of the rotation device for a complete rolling, the rolling device can have two, three, four or more rolling elements directed inward.

In another embodiment, the rotation device is coupled to a drive unit of another rolling machine. A rotation can thus be applied to the rotation device by means of the rolling machine, so that a complete rolling of the eccentric worm shaft can be carried out.

The tool preferably has a displacement device. Surfaces can thus be rolled along the direction of a rotational axis of the rotation component. It must hereby be pointed out that the rolling machine can also or alternately have such a displacement device. A whirling machine more specifically can lead the eccentric rotational component by a feed motion through the tool in such a manner that a displacement of the hydrostatic burnishing elements in or against the feed direction can be dispensed with.

In order to adapt the rolling device to the component to be machined, more specifically to the eccentric rotational component, the tool can have a centering device. This centering device can be configured in such a manner that a uniform adaptation to the eccentric rotational component occurs.

In another embodiment, the tool is configured in such a manner, that a roll force of 1000 N to 20000 N acts on the eccentric rotational component. Depending on the intended use, the roll force can most preferably amount to approximately 4000 N. Advantageous properties can thus be applied to the eccentric worm shaft. Amongst others, this is due to the fact that the roll force can cause a modification of the surface of the eccentric rotational component.

In order to ensure a further improvement of the properties of the eccentric worm shaft, the tool can be configured in such a manner that a hardening of a surface edge zone of 2% to 40%, more specifically of 10% to 20% occurs.

In another embodiment, the rotation device can be subjected to a rotational speed of the rotation device of 100 revolutions per minute to 2000 revolutions per minute, more specifically 500 revolutions per minute to 800 revolutions per minute.

The rotational speed of the rotation device can be higher than the rotational speed applied to the eccentric rotational component, so that the entire surface of the eccentric rotational component can be rolled. The rotational speed of the rotation device can be linked to the rotational speed of the eccentric rotational component via a gear.

In order to manufacture an eccentric rotational component from an un-machined rotational component, the tool can have a peeling device for machining an un-machined rotational component in such a manner that the eccentric rotational component is produced by this machining.

In another aspect of the disclosure, the object is solved by a rolling machine, more specifically a whirling machine or a lathe with a previously described tool.

Thereby a machine can be provided with which a rolled eccentric rotational component can be manufactured. It must be pointed out that the whirling machines are standard machines for manufacturing eccentric worm shafts.

In another aspect of the disclosure, the object can be solved by a method for manufacturing a rolled eccentric rotational component, in which an eccentric rotational component is manufactured by means of the previously described rolling machine. The eccentric rotational component or the un-machined rotational component is thereby fastened in the rolling machine with the previously described tool in such a manner that the eccentric rotational component can be produced by machining.

The object is solved furthermore by an eccentric rotational component which has been manufactured according to the previously described method.

In an additional aspect of the disclosure, the object can be solved by an eccentric rotational component in which an eccentric part is rolled.

In order to provide a low-wear eccentric rotational component, a surface edge zone of the eccentric part can be hardened by 2% to 40%, more specifically by 10% to 20%.

In another embodiment, the eccentric part is rolled with a roll force of 1000 N to 20000 N, more specifically with 4000 N. A special type of machining of the surface of the eccentric rotational component can thus be provided.

In order to be able to roll previously hardened eccentric rotational components, a part of the eccentric rotational component can be hardened before rolling. Prefabricated and hardened eccentric worm shafts can thus be rolled.

In another aspect of the disclosure, the object can be solved by a rolling method for manufacturing a rolled eccentric rotational component, whereby an un-machined rotational component is peeled in a first step and an eccentric part is rolled in a second step and both steps are carried out in a rolling machine clamping. Thereby, the peeling can occur by means of a ceramic tool.

An eccentric rotational component can thus be manufactured from an un-machined rotational component which is also rolled at the same time. A separate clamping and resulting errors or material or machining damages can thus be omitted.

The peeling tool can be combined with a rolling tool or the tools can be changed without changing the clamping. When the peeling tool and the rolling tool are combined, a distance between the two tools can preferably be adjusted.

### BRIEF DESCRIPTION OF THE DRAWINGS

In the following, the disclosure is described in more detail by means of an exemplary embodiment with the help of the FIGS. 1 to 6. In the drawings:

FIG. 1a shows a schematic front view of a rotation device with a rolling device,

FIG. 1b shows another schematic front view of the rotation device with a rolling device,

FIG. 2 shows a schematic lateral view of the rotation device with a rolling device and a stator,

FIG. 3 shows a schematic front view of a partial section of the rotation device,

FIG. 4 shows a schematic three-dimensional view of the rotation device with a rolling device and a corresponding stator,

FIG. 5 shows a schematic three-dimensional view of the rotation device with a rolling device and an inserted eccentric worm shaft.

FIG. 6 shows a schematic lateral view of a hydrostatic burnishing element which acts onto the eccentric worm shaft and a schematic front view of the eccentric worm shaft.

### DETAILED DESCRIPTION OF THE PREFERRED EMBODIMENT

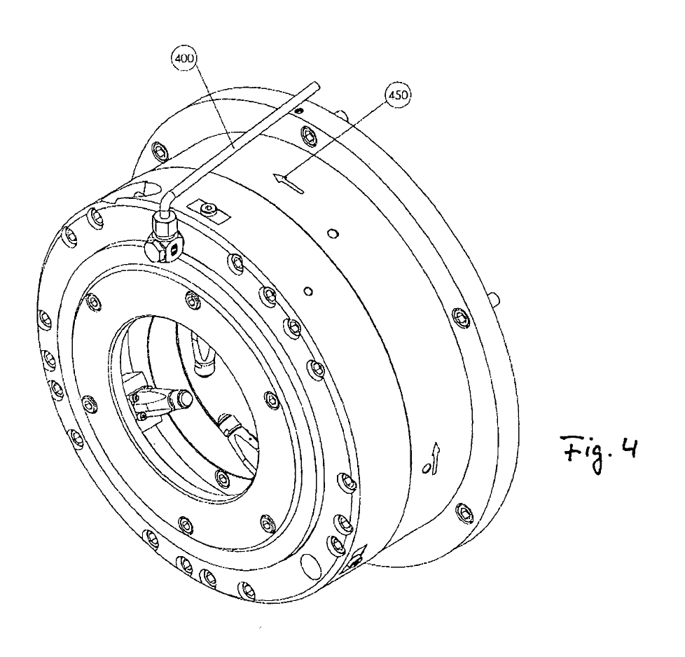

In the following, the operating mode of the disclosure is described more specifically with reference to FIG. 5.

A tool A shows a rotation device R with attached hydrostatic burnishing elements 410. The tool A is coupled to a whirling machine.

In the following, an eccentric worm shaft B is fed in a feed direction V through the tool A by means of a whirling machine (not shown). The feed speed amounts to 0.2 mm per rotation of the rotation device R. The whirling machine is configured in such a manner that eccentric parts of the eccentric worm shaft B are evened out at a contact feed position 510, so that a vertical and/or horizontal displacement of the hydrostatic burnishing elements 410 is dispensed with. The whirling machine thus ensures that in a certain position relative to the feed direction, the eccentric worm shaft always has the same vertical and horizontal position perpendicular to the feed direction during the feed motion of the eccentric worm shaft B.

During rolling, the rotation device R rotates in the direction of the arrow around the eccentric worm shaft B. The hydrostatic burnishing elements 410 connected to the rotation device thereby apply a force of 4000 N onto the eccentric worm shaft B. A rolling of the eccentric worm shaft B thus occurs. Due to the rotation of the rotation device R, the eccentric worm shaft B is completely rolled at the contact feed position 510.

The whirling machine feeds the eccentric worm shaft B further in the feed direction V, so that a non rolled part of the eccentric worm shaft B rests on the contact feed position 510. Due to the rotation of the rotation element R and the ensuing rolling by means of the burnishing elements, the previously not rolled part of the eccentric worm shaft B is rolled.

This procedure repeats until the entire eccentric worm shaft B has been rolled.

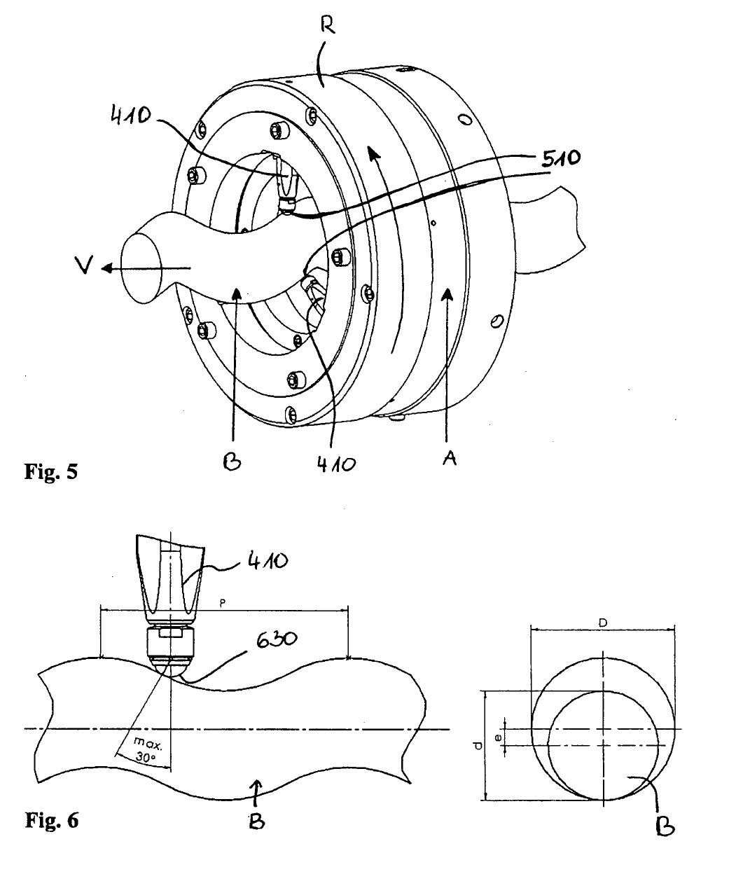

As can be seen in FIG. 6, the burnishing elements 410 have a ball-shaped tip 630, 410.2. Due to its ball shape, the burnishing element 410 can slightly adapt to the pitch of the eccentric worm.

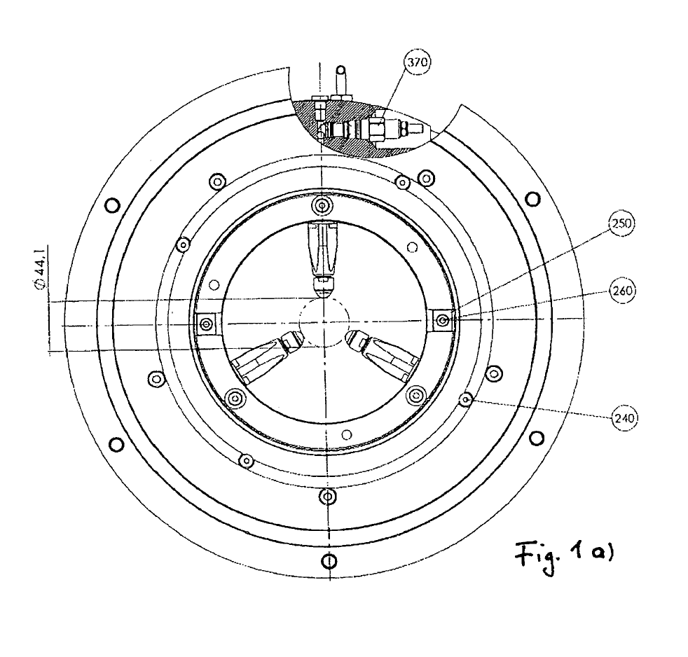

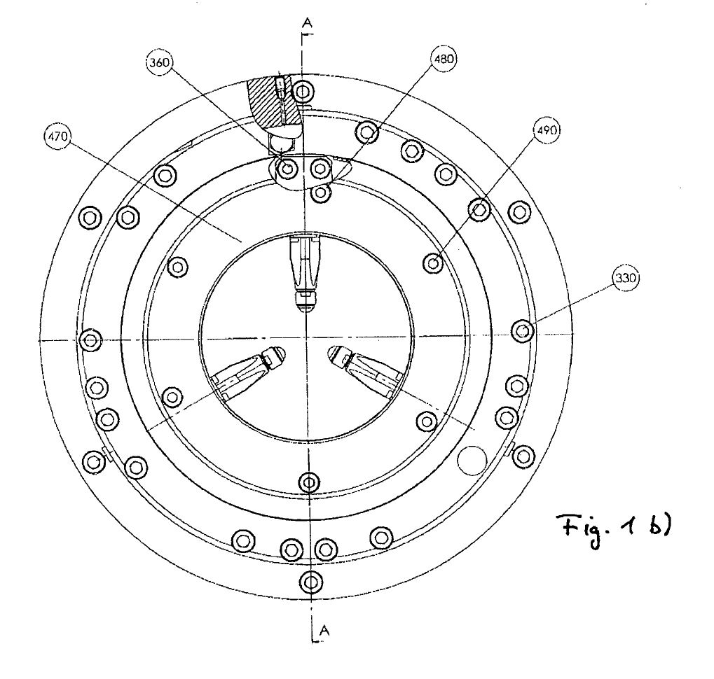

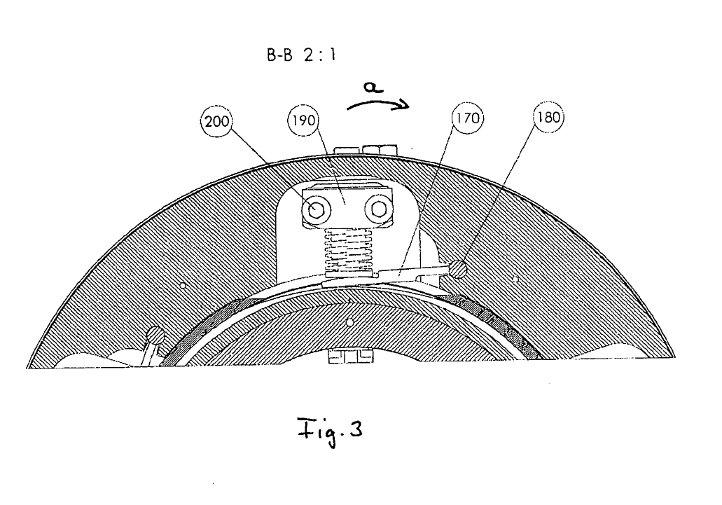

In the following, the configuration of the tool A is explained by means of FIGS. 1 to 4.

The rotation element R is connected to a stator. The stator comprises a receptacle 10 with three sealing pistons 270 and a grub screw 40 as well as a bearing ring 100 and a cam ring 50 and two angular ball bearings 20, 80.

The tool A is connected in a rotatably fixed manner to a vertical part of the whirling machine by means of the stator with its sealing pistons 270 and the catch 250. The catch 250 secures the stator against rotation.

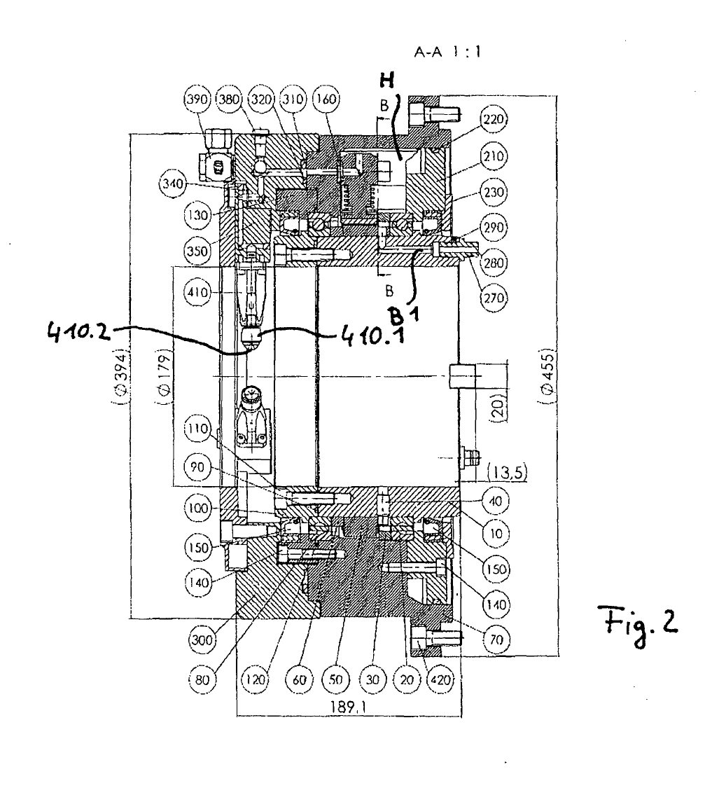

A cooling lubricant which is necessary for the rolling process is supplied via a sealing piston 270 and led via the bores B1 of the receptacle 10 into a cavity H of the casing 70. Oil can alternately be used as a cooling lubricant. The shaft sealing rings 150 prevent an undesired fluid loss from the cavity H. The pump elements 190 rotate in the direction a (see FIG. 3) around the fixed cam ring 50 which has a lifting height h=7 mm.

The grub screw 40 prevents a simultaneous rotation of the cam ring 50. The 7 mm lifting height of the cam ring 50 is transformed into a lifting motion on the pistons of the pump elements 190. The sliding pieces 170 prevent the appearance of a shear force on the pistons of the pump elements 190.

The rotation device R comprises the casing 70 with the centering unit and six bores for screwing the tool A onto the whirling machine. The five pump elements 190 are mounted in the casing 70.

Sliding pieces 170 prevent a direct contact of the pistons of the pump elements 170 with the cam ring 50. The flange 210 is screwed into the casing 270 and receives the shaft sealing ring 150 which is maintained in position by the holding plate 230.

The intermediate piece 300 is screwed against the casing 70. Beside the pressure control valve 370, this intermediate piece 300 receives the burnishing elements 410 which act here as a rolling device via the adapter 350.

The ring 470 serves to stabilize the burnishing elements 410. The cover 130 screwed onto the casing 70 is located between the casing 70 and the intermediate piece 300. It receives the shaft sealing ring 150. The burnishing elements acting as a rolling device 410 deploy the ball insert 410.1 inside their lift of 8.5 mm until the ball 410.2 comes in contact with the work piece surface.

The work piece is continuously burnished or roller compressed by the rotation of the rotation element R with rolling elements oriented radially inward and a simultaneous feed motion. The pressure and feed motion being freely selectable, the rolling results can be outstandingly influenced and optimized.

The burnishing of hardened components is made possible by using hard material components in the burnishing elements 410.

1. A tool for rolling an eccentric rotational component with an eccentric part, more specifically an eccentric worm shaft, wherein the tool has a rotation device with a rolling device, so that the eccentric part can be rolled through the rolling device.

2. The tool according to claim 1, further comprising a stator which is static relative to the rotation device.

3. The tool according to claim 1, wherein the rolling device has a hydrostatic burnishing element, more specifically a ball insert with a hard material component.

4. The tool according to claim 1, wherein the rolling device or the burnishing element has a lift of 1 mm to 20 mm.

5. The tool according to claim 1, wherein the rolling device has two, three, four or more burnishing elements.

6. The tool according to claim 1, wherein the rotation device is coupled to a drive unit of a rolling machine.

7. The tool according to claim 1, further comprising a displacement device.

8. The tool according to claim 1, further comprising a centering device.

9. The tool according to claim 1, wherein it is configured in such a manner that a rolling force of 1000 N to 20000 N acts on the eccentric rotational component.

10. The tool according to claim 1, wherein it is configured in such a manner that a hardening of the surface edge zone of 2% to 40% occurs.

11. The tool according to claim 1, wherein a rotational speed of 100 revolutions per minute to 2000 revolutions per minute can be applied to the rotation device.

12. The tool according to claim 1, wherein it has a peeling device for machining an un-machined rotational component, so that the eccentric rotational component is produced by this machining.

13. A rolling machine, more specifically a whirling machine or a lathe, with a tool for rolling an eccentric rotational component with an eccentric part, more specifically an eccentric worm shaft, wherein the tool has a rotation device with a rolling device, so that the eccentric part can be rolled through the rolling device.

14. A method for manufacturing a rolled eccentric rotational component in which an eccentric rotational component is manufactured by means of the rolling machine, more specifically a whirling machine or a lathe, with a tool for rolling an eccentric rotational component with an eccentric part, more specifically an eccentric worm shaft, wherein the tool has a rotation device with a rolling device, so that the eccentric part can be rolled through the rolling device.

15. An eccentric rotational component, which is manufactured either according to (a) a method for manufacturing a rolled eccentric rotational component in which an eccentric rotational component is manufactured by means of the rolling machine, more specifically a whirling machine or a lathe, with a tool for rolling an eccentric rotational component with an eccentric part, more specifically an eccentric worm shaft, wherein the tool has a rotation device with a rolling device, so that the eccentric part can be rolled through the rolling device or (b) with a tool for rolling an eccentric rotational component with an eccentric part, more specifically an eccentric worm shaft, wherein the tool has a rotation device with a rolling device, so that the eccentric part can be rolled through the rolling device.

16. An eccentric rotational component, in which an eccentric part is rolled.

17. The eccentric rotational component according to claim 15, the surface edge zone of the eccentric part being hardened by 2% to 40%.

18. The eccentric rotational component according to claim 15, wherein the eccentric part is rolled with a roll force of 1000 N to 20000 N.

19. The eccentric rotational component according to claim 15, wherein a part of the eccentric rotational component is hardened.

20. A rolling method for manufacturing a rolled eccentric rotational component, in which an un-machined rotational component is peeled in a first step, an eccentric part is rolled in a second step and both steps are carried out in a rolling machine clamping.
